(19) United States
(12) Patent Application Publication
(10) Pub. No.: US 2005/0264929 A1
(43) Pub. Date: Dec. 1, 2005

(54) Disk drive unit and disk device provided with the same

(75) Inventors: Toshikuni Sato, Fussa-shi (JP); Takahide Miyahara, Kawasaki-shi (JP); Tomomi Wakabayashi, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/137,805

(22) Filed: May 26, 2005

(30) Foreign Application Priority Data
May 28, 2004 (JP) 2004-159496

(51) Int. Cl. G11B 17/08

(52) U.S. Cl. 360/99.12

(57) ABSTRACT

A disk drive unit includes a spindle motor, which has a pivot and a substantially cylindrical hub which is rotatably supported on the pivot and constitutes a rotor. A disk is fitted coaxially on the hub, and an annular clamp member holding the disk is fitted on an end portion of the hub. The clamp member has an inner peripheral edge fitted on an outer peripheral surface of the hub, a plurality of engaging portions spaced in the circumferential direction thereof and capable of engaging a removing tool, and a plurality of notch portions which are formed along the inner peripheral edge between the engaging portions and define gaps outside the outer peripheral surface of the hub.

### CROSS-REFERENCE TO RELATED APPLICATIONS

This application is based upon and claims the benefit of priority from prior Japanese Patent Application No. 2004-159496, filed May 28, 2004, the entire contents of which are incorporated herein by reference.

### BACKGROUND OF THE INVENTION

1. Field of the Invention

This invention relates to a disk drive unit for driving disks as recording media and a disk device provided with the same.

2. Description of the Related Art

In recent years, disk devices, such as magnetic disk devices, optical disk devices, etc., have been widely used as external recording devices of computers and image recording devices.

A magnetic disk device as an example of a disk device generally has a case in the form of a rectangular box. The case contains magnetic disks for use as magnetic recording media, a disk drive unit, magnetic heads, and a head actuator. The disk drive unit supports and rotates the disks. The magnetic heads are used to write and read information to and from the disks. The head actuator supports the magnetic heads for movement with respect to the magnetic disks. Further, the case contains a voice coil motor, a substrate unit, etc. The voice coil motor rocks and positions the head actuator. The substrate unit has a head IC and the like.

A printed circuit board for controlling the respective operations of the spindle motor, voice coil motor, and magnetic heads through the substrate unit is screwed to the outer surface of the case. An interface (I/F) connector for connecting the magnetic disk device to an external device is mounted to an end portion of the circuit board.

A disk drive unit described in Jpn. Pat. Appln. KOKAI Publication No. 9-115216, for example, is provided with a spindle motor that supports and rotates magnetic disks. The spindle motor has a substantially cylindrical hub that constitutes a rotor, and the magnetic disks are fitted on the hub. A clamp ring is fitted on one end portion of the hub and prevents the disks from slipping off. The clamp ring is fitted on the hub by so-called shrink fitting. More specifically, the clamp ring is fitted on the hub after being heated to be expanded. Thereafter, the ring is cooled to be shrunk so that it fits the hub in a desired fit.

In removing the magnetic disks from the hub of the spindle motor for the purpose of repair, adjustment, etc., in the disk drive unit constructed in this manner, the clamp ring is disengaged first. In doing this, shafts of the removing tool are caused to engage the clamp ring. Thereupon, a plurality of parts of the clamp ring are spread uniformly radially outward. In this state, the clamp ring is pulled and disengaged from the hub.

If a plurality of parts of the clamp ring are spread radially outward in this manner, however, those parts which are situated between the spread parts move radially inward or toward the center of the hub to be pressed against the outer peripheral surface of the hub. If the clamp member is drawn out, a plurality of its moving parts slide on the outer peripheral surface of the hub, thereby possibly marring the hub surface. If the surface is thus marred, the perimeters of mars swell, so that the outside diameter of the hub changes inevitably. It is difficult, therefore, to fit the magnetic disks and the clamp member again on the hub, so that the hub must be replaced with a new one or reprocessed. Thus, the conventional disk drive unit has problems that its parts replacement, repair, and adjustment are troublesome and its cost is high.

### BRIEF SUMMARY OF THE INVENTION

According to an aspect of the invention, there is provided a disk drive unit comprising: a spindle motor having a pivot and a substantially cylindrical hub which is rotatably supported on the pivot and constitutes a rotor; a disk-shaped recording medium fitted coaxially on the hub; and an annular clamp member which is fitted on an end portion of the hub and holds the recording medium. The clamp member has an inner peripheral edge fitted on an outer peripheral surface of the hub, a plurality of engaging portions spaced in the circumferential direction thereof and capable of engaging a removing tool, and a plurality of notch portions which are formed along the inner peripheral edge between the engaging portions and define gaps between the inner peripheral edge of the clamp member and the outer peripheral surface of the hub.

According to another aspect of the invention, there is provided a disk device comprising: a case; the disk drive unit located in the case; a head which processes information for the recording medium; and a head actuator which is provided in the case, supports the head for movement, and moves the head with respect to the recording medium.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a hard disk drive (hereinafter referred to as an HDD) according to an embodiment of the invention;

FIG. 2 is an exploded perspective view of the HDD;

FIG. 3 is a plan view showing a case and the internal structure of the HDD;

FIG. 4 is a sectional view of the HDD taken along line IV-IV of FIG. 1;

FIG. 5A is a plan view showing a clamp ring of the HDD;

FIG. 5B is a sectional view showing the clamp ring of the HDD;

FIG. 6 is a side view showing a radial dynamic pressure generating portion of a fluid bearing in the HDD;

FIG. 7 is a sectional view showing a thrust dynamic pressure generating portion of the fluid bearing in the HDD; and

FIG. 8 is a plan view showing a clamp ring according to another embodiment of the invention.

### DETAILED DESCRIPTION OF THE INVENTION

An HDD according to an embodiment of this invention will now be described with reference to the accompanying drawings.

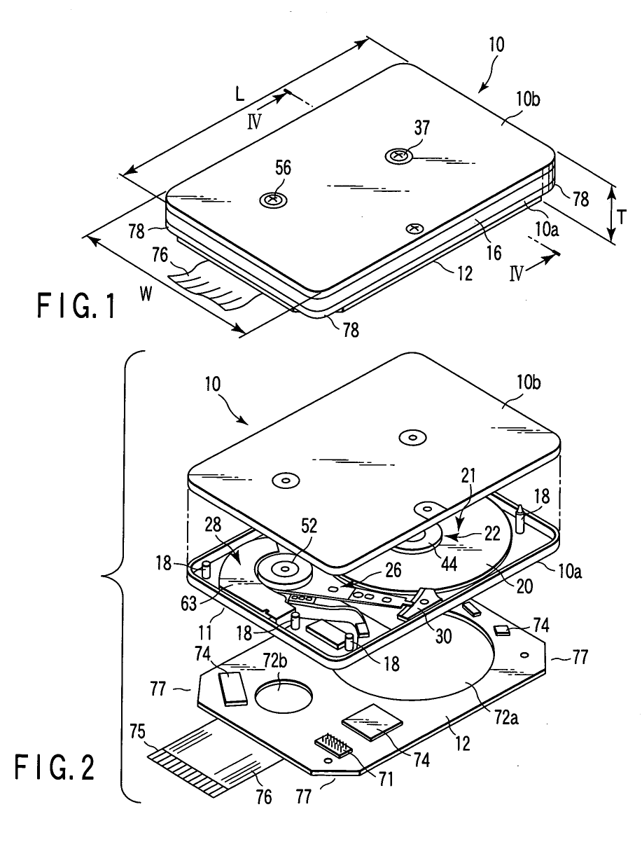

As shown in FIGS. 1 and 2, the HDD comprises a case 10 in the form of a substantially rectangular box and a rectangular control circuit board 12. The case 10 contains various members, which will be described later. The circuit board 12 is overlapped on the outer surface of the case 10. The case 10 and the circuit board 12 each have a length L of 32 mm and a width W of 24 mm. A thickness T of a structure that combines the case and the control circuit board ranges from about 3 to 6 mm. The thickness T is adjusted to, e.g., about 3.3 mm or 6 mm, depending on the number of disks to be held in the case.

As shown in FIGS. 2 to 4, the case 10 comprises a first shell 10a and a second shell 10b that have substantially equal dimensions. The first and second shells 10a and 10b are substantially rectangular metallic structures, which have sidewalls set up on their respective peripheral edge portions. The shells 10a and 10b are arranged facing each other with their peripheral edge portions opposed. A belt-shaped seal member 16 is wound around the peripheral edge portions of the shells 10a and 10b. The seal member 16 connects the peripheral edge portions of the shells and seals a gap between them. Thus, the case 10 is formed having the shape of a rectangular box.

The bottom surface of the first shell 10a forms a rectangular mounting surface 11. Four corners of the case 10, including the corners of the mounting surface 11, are rounded in a circular arc. Thus, the seal member 16 that is wound around the peripheral edge portion of the case 10 is prevented from being damaged by the corners of the case, and airtightness is prevented from being lowered by lifting of the seal member.

In the case 10, a plurality of support posts 18 are provided on the peripheral edge portion of the case. Each support post 18 has a proximal end fixed to the inner surface of the first shell 10a and is set substantially upright on the inner surface of the first shell. Corresponding to each support post 18 in position, a tapped hole is formed in the mounting surface 11 and extends into the post.

The case 10 contains a magnetic disk 20 of, e.g., 0.85-inch diameter, for use as an information recording medium, a disk drive unit 21, a magnetic head 24, and a carriage 26. The disk drive unit 21 supports and rotates the disk 20. The magnetic head 24 is used to write and read information to and from the disk 20. The carriage 26 supports the magnetic head 24 for movement with respect to the magnetic disk 20. Further, the case 10 contains a voice coil motor (VCM) 28, a ramp load mechanism 30, a solenoid latch 32, a substrate unit 34, etc. The VCM 28 rotates and positions the carriage 26. The ramp load mechanism 30 unloads into and holds the magnetic head 24 in a position off the magnetic disk 20 when the head is moved to the peripheral edge portion of the disk. The solenoid latch 32 holds the carriage 26 in a shunt position. The substrate unit 34 has a head IC and the like.

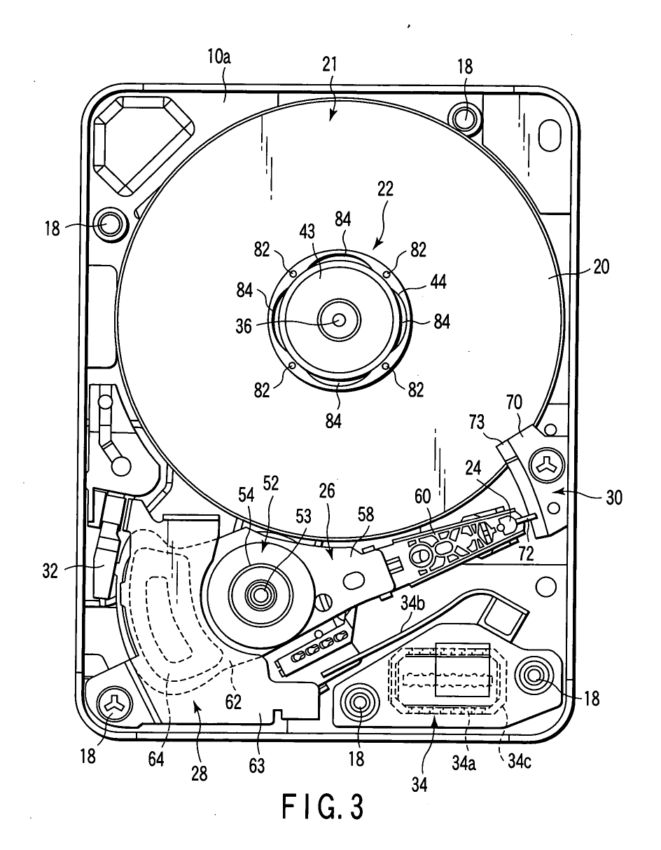

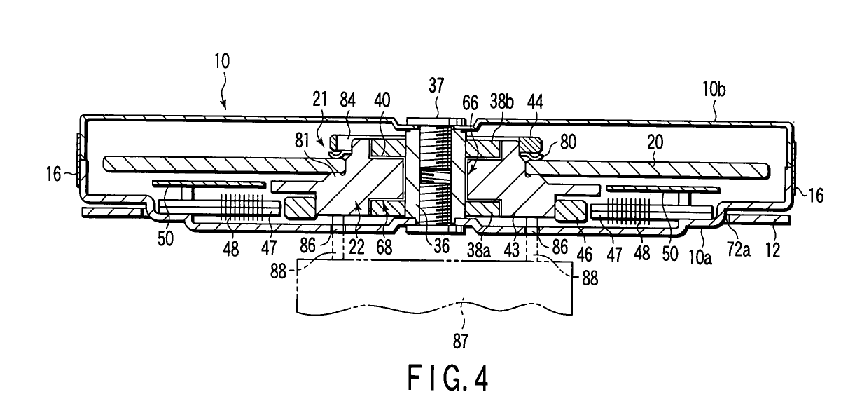

As shown in FIGS. 3 and 4, the disk drive unit 21 is provided with a spindle motor 22 that is mounted on the first shell 10a. The motor 22 has a pivot 36, which is fixed to the inner surface of the first shell 10a and set substantially upright on it. An extended end of the pivot 36 is screwed to the second shell 10b by a fixing screw 37 that is externally screwed into the second shell. Thus, the pivot 36 is dually supported by the first and second shells 10a and 10b.

A substantially cylindrical hub 43 that constitutes a rotor is rotatably supported on the pivot 36 by a fluid bearing. More specifically, annular flange members 38a and 38b are fitted coaxially on the opposite end portions of the pivot 36. The inner surface of the hub 43 is shaped corresponding to the pivot 36 and the flange members 38a and 38b and face them across a fine gap of about 2 to 15 μm. The fine gap between the hub 43 and the pivot 36 and the flange members 38a and 38b is filled with lubricating oil 40 for use as a dynamic pressure generating fluid.

A radial dynamic pressure generating portion 66 is provided in the fine gap between the outer peripheral surface of the pivot 36 and the inner peripheral surface of the hub 43. A thrust dynamic pressure generating portion 68 is formed in the fine gap between the upper surface of the lower flange member 38a and the hub 43. As shown in FIG. 6, the radial dynamic pressure generating portion 66 has a plurality of radial dynamic pressure generating grooves 67, herringbone grooves that are formed on the outer peripheral surface of the pivot 36. The grooves 67 are formed side by side in the circumferential direction of the pivot 36 so as to cover its whole circumference. When the hub 43 rotates, the grooves 67 cause the lubricating oil 40 in the fine gap to generate a radial dynamic pressure.

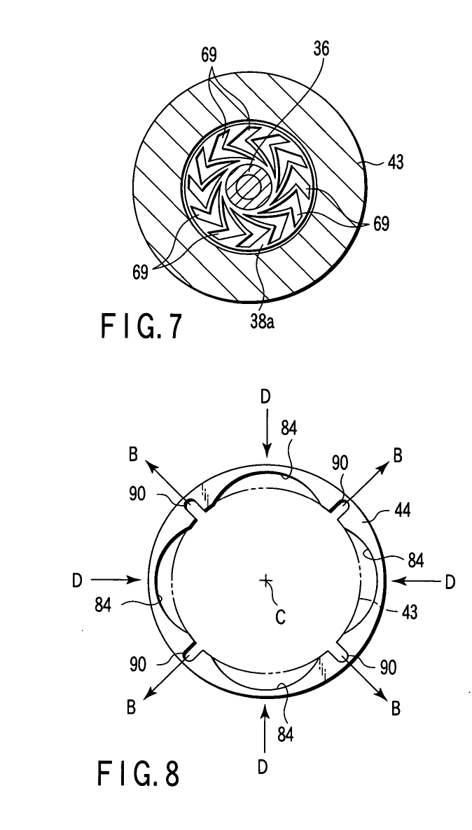

As shown in FIG. 7, the thrust dynamic pressure generating portion 68 has a plurality of thrust dynamic pressure generating grooves 69 that are formed on the upper surface of the flange member 38a. The thrust dynamic pressure generating grooves 69 are herringbone grooves that are arranged in the circumferential direction around the pivot 36. When the hub 43 rotates, the grooves 69 cause the lubricating oil 40 in the fine gap to generate a thrust dynamic pressure.

As shown in FIGS. 3 and 4, the magnetic disk 20 is fitted coaxially on an end portion of the hub 43 on the side of the second shell 10b. Further, an annular clamp spring 80 is mounted on the end portion of the hub 43, and a clamp ring 44 is fitted overlapping the clamp spring. The inner peripheral edge portion of the disk 20 and the spring 80 are pressed down and prevented from slipping off by the clamp ring 44. The inner peripheral edge portion of the disk 20 is urged in the axial direction of the pivot 36 and pressed against a flange 81 of the hub 43 by the clamp spring 80. Thus, the magnetic disk 20 is fixed to the hub 43 and supported for rotation integral with the hub.

As shown in FIGS. 3, 4, 5A and 5B, the clamp ring 44 that serves as a clamp member is a ring-shaped stainless-steel structure. The clamp ring 44 has an inner peripheral edge fitted on the outer peripheral surface of the hub 43, through holes 82, and notch portions 84. The through holes 82 are spaced in the circumferential direction and can engage a removing tool. The notch portions 84 are formed along the inner peripheral edge of the ring 44 between the through holes 82 and define gaps between the inner peripheral edge of the ring and the outer peripheral surface of the hub 43.

The through holes 82 are three or more, e.g., four, in number and are arranged at equal distances in the circumferential direction of the clamp ring 44. The notch portions 84 are as many as the through holes 82 and are arranged alternately with the through holes 82 in the circumferential direction of the ring 44. The notch portions 84 and the through holes 82 are located symmetrically with respect to a point, that is, a rotation center C of the hub 43. Each notch portion 84 has the shape of a circular arc, and that part of it which is kept widest apart from the inner peripheral surface of the hub 43 is situated halfway between its corresponding two adjacent through holes 82.

The clamp ring 44 constructed in this manner is fitted on the end portion of the hub 43 by so-called shrink fitting. More specifically, the ring 44 is fitted on the hub 43 after being heated to be expanded. Thereafter, the ring is cooled to be shrunk so that it fits the hub in a desired fit.

As shown in FIG. 4, an annular permanent magnet 46 is fixed to an end portion of the hub 43 on the side of the first shell 10a so to be coaxial with the hub. The spindle motor 22 has a stator core 47 attached to the first shell 10a and a plurality of coils 48 wound on the stator core. The stator core and the coils are located outside and spaced from the magnet 46. An annular shield plate 50 is attached to the first shell 10a and located between the coils 48 and the magnetic disk 20.

The first shell 10a is formed having a plurality of through holes 86 that are situated opposite the lower surface of the hub 43. In mounting the magnetic disk 20 and the clamp ring 44 on the hub 43, support rods 88 of a jig 87 are externally inserted into the case 10 through the through holes 86 so that the hub 43 can be supported by the support rods. Thus, the magnetic disk 20 and the clamp ring 44 can be mound without damaging the fluid bearing.

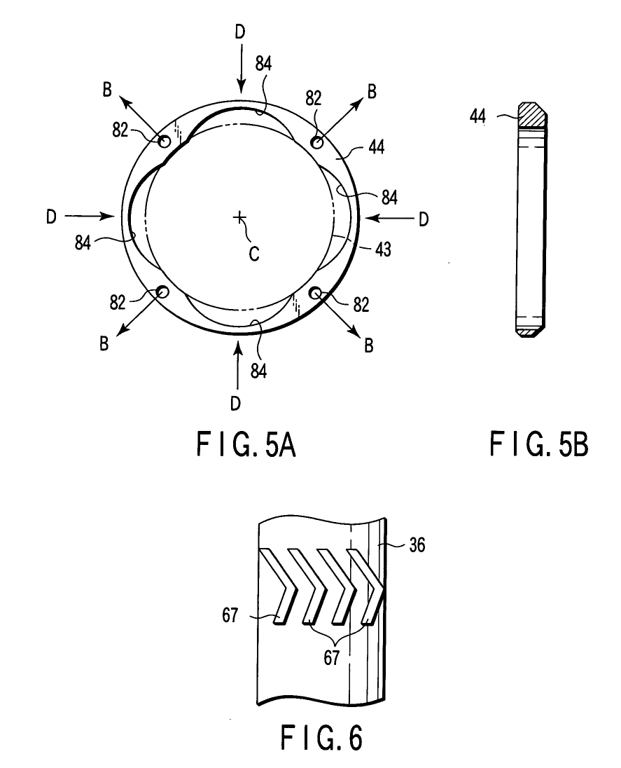

In removing the magnetic disk 20 from the hub 43 of the spindle motor 22 for the purpose of repair, adjustment, etc., on the other hand, the clamp ring 44 is disengaged first. As shown in FIG. 5A, in doing this, shafts of the removing tool are caused individually to engage the through holes 82 of the clamp ring 44 that serve as engaging portions. Thereupon, four parts of the clamp ring 44 are spread uniformly radially outward (in the direction of arrows B). In this state, the clamp ring 44 is pulled and disengaged from the hub 43. If a plurality of parts of the ring 44 are spread radially outward, those parts which are situated between the spread parts move radially inward or toward the center C of the hub 43, as indicated by arrows D. Since the notch portions 84 are formed in these parts, however, the inside diameter of the clamp ring 44 cannot be reduced to a level smaller than the diameter of the hub 43, so that the gaps are maintained between the hub 43 and the inner peripheral edge of the clamp ring. Thus, the clamp ring 44 can be easily removed from the hub 43 without damaging the hub 43 or the magnetic disk 20.

As shown in FIGS. 2 and 3, the carriage 26 that constitutes a head actuator comprises a bearing assembly 52 that is fixed on the inner surface of the first shell 10a. The bearing assembly 52 has a pivot 53 and a cylindrical sleeve 54. The pivot 53 is set upright on the inner surface of the first shell 10a. The sleeve 54 is rotatably supported on the pivot 53 by a pair of bearings. An extended end of the pivot 53 is screwed to the second shell 10b by a fixing screw 56 that is externally screwed into the second shell. Thus, the pivot 53 is dually supported by the first and second shells 10a and 10b. The bearing assembly 52 that serves as a bearing portion is located side by side with the spindle motor 22 in the longitudinal direction of the case 10.

The carriage 26 comprises an arm 58 extending from the sleeve 54, a suspension 60 in the form of an elongate plate extending from the distal end of the arm, and a support frame 62 extending from the sleeve 54 in a direction opposite from the arm. The magnetic head 24 is supported on an extended end of the suspension 60 by a gimbals portion (not shown). The head 24 is subjected to a given head load toward the surface of the magnetic disk 20 by a spring force of the suspension 60. A voice coil 64 that constitutes the VCM 28 is fixed integrally to the support frame 62.

The VCM 28, which serves to rock the carriage 26 around the bearing assembly 52, comprises a pair of yokes 63 and a magnet (not shown). The yokes 63 are fixed on the first shell 10a and opposed to each other with a gap between them. The magnet is fixed to the inner surface of one of the yokes and opposed to the voice coil 64. When the coil 64 is energized, the carriage 26 rotates between the shunt position shown in FIG. 3 and an operating position above the surface of the magnetic disk 20. The magnetic head 24 is positioned on a desired track of the disk 20. The solenoid latch 32 that is fixed to the first shell 10a latches the carriage 26 that is moved to the shunt position, thereby preventing the carriage from moving from the shunt position to the operating position if the HDD is subjected to any external force, such as a shock.

The ramp load mechanism 30 comprises a ramp member 70 and a tab 72. The ramp member 70 is fixed to the inner surface of the first shell 10a and situated opposite the peripheral edge portion of the magnetic disk 20. The tab 72 extends from the distal end of the suspension 60 and serves as an engaging member. The ramp member 70 is formed by bending a plate material and has a ramp surface 73 that can be engaged by the tab 72. When the carriage 26 rocks from the inner peripheral portion of the disk 20 to the shunt position outside the disk, the tab 72 engages the ramp surface 73 of the ramp member 70. Thereafter, the tab 72 is pulled up along a slope of the ramp surface to unload the magnetic head 24. When the carriage 26 rocks to the shunt position, the tab 72 is supported on the ramp surface 73 of the ramp member 70. Thereupon, the magnetic head 24 is kept off the surface of the magnetic disk 20.

The substrate unit 34 has a body 34a that is formed of a flexible printed circuit board. The body 34a is fixed to the inner surface of the first shell 10a. Electronic components, such as the head IC, a head amplifier, etc., are mounted on the body 34a. The substrate unit 34 has a main flexible printed circuit board (main FPC) 34b that extends from the body 34a. An extended end of the main FPC 34b is connected to that part of the carriage 26 which is situated near the bearing assembly 52. Further, the extended end is connected electrically to the magnetic head 24 by a cable (not shown) that is located on the arm 58 and the suspension 60. A connector 34c for connection with the control circuit board 12 is mounted on the bottom surface of the body of the substrate unit 34. The connector 34c is exposed to the mounting surface 11 of the first shell 10a through an opening in the first shell.

The control circuit board 12, a printed circuit board, is a rectangular structure that is substantially equal to the mounting surface 11 of the case 10 in length and width. The control circuit board 12 is formed having circular openings 72a and 72b that correspond individually to protrusions (not shown) on the mounting surface. Four corner portions of the control circuit board 12 are obliquely cut at, e.g., 45 degrees to each side, and individually form notch portions 77. A plurality of electronic components 74 and a connector 71 are mounted on the control circuit board 12. Further, a flexible printed circuit board 76 for electrical connection between the HDD and an external device is connected to the control circuit board 12. It is drawn out through one short side of the circuit board 12, and a plurality of connector terminals 75 are formed on its extended end.

The control circuit board 12 is overlapped on the mounting surface 11 of the case 10 and screwed the first shell 10a with screws. As this is done, the circuit board 12 is located with its four sides aligned or coincident individually with four sides of the mounting surface 11. The connector 71 on the circuit board 12 is connected to the connector on the substrate unit 34.

The notch portions 77 at the four corner portions of the control circuit board 12 are situated corresponding individually to the four corner portions of the mounting surface 11. Thus, the four corner portions of the mounting surface 11 are exposed to the outside without being covered by the circuit board 12. The corner portions of the case 10, including the four exposed corner portions of the mounting surface 11, individually constitute retaining portions 78 for holding the case without contact with the circuit board 12.

According to the HDD constructed in this manner, the clamp ring 44 of the disk drive unit 21 has the through holes 82 and the notch portions 84. The through holes 82 can individually engage the removing tool. The notch portions 84 are formed along the inner peripheral edge of the ring 44 between the through holes 82 and define gaps outside the outer peripheral surface of the hub 43. Thus, the clamp ring 44 can be easily removed from the hub 43 of the spindle motor 22 without damaging the hub 43 or the magnetic disk 20. In consequence, the disk drive unit 21 and the HDD can be easily repaired and adjusted at low cost.

According to the HDD described above, the first and second shells 10a and 10b that constitute the case 10 are supported opposite to each other with the given gap between them by the support posts 18 that are set up on one of the shells. If any external force acts on the case 10, therefore, the case and the components therein can be prevented from being damaged. With use of the support posts 18, screwed portions between the shells 10a and 10b can be reduced in number, and assemblability and maintainability can be improved.

The present invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

In the embodiment described above, the engaging portions of the clamp ring 44 are formed of the through holes 82. Alternatively, however, they may be formed of slits 90 that open in the inner peripheral edge of the clamp ring 44, as shown in FIG. 8. Each notch portion 84 is not limited to the shape of a circular arc but may be of any other shape. The number of engaging portions or notch portions is not limited to four but should only be two or more.

The number of magnetic disk(s) or head(s) is not limited to one but may be increased as required. Further, the size of the magnetic disk used is not limited to 0.85 inch but may alternatively be 1.8 or 2.5 inches.

1. A disk drive unit comprising:
a spindle motor having a pivot and a substantially cylindrical hub which is rotatably supported on the pivot and constitutes a rotor;
a disk-shaped recording medium fitted coaxially on the hub; and
an annular clamp member which is fitted on an end portion of the hub and holds the recording medium,
the clamp member having an inner peripheral edge fitted on an outer peripheral surface of the hub, a plurality of engaging portions spaced in the circumferential direction thereof and capable of engaging a removing tool, and a plurality of notch portions which are formed along the inner peripheral edge between the engaging portions and define gaps between the inner peripheral edge of the clamp member and the outer peripheral surface of the hub.

2. A disk drive unit according to claim 1, wherein each of the engaging portions has a through hole formed in the clamp member.

3. A disk drive unit according to claim 1, wherein each of the engaging portions has a slit formed in the clamp member and opening in the inner peripheral edge.

4. A disk drive unit according to claim 1, wherein three or more said engaging portions are arranged at equal distances in the circumferential direction of the clamp member.

5. A disk drive unit according to claim 1, wherein the notch portions are as many as the engaging portions and are arranged alternately with the engaging portions in the circumferential direction of the clamp member.

6. A disk drive unit according to claim 1, wherein the notch portions and the engaging portions are located symmetrically with respect to a rotation center of the hub.

7. A disk drive unit according to claim 1, wherein each of the notch portions has the shape of a circular arc and that part of the notch portion which is kept widest apart from the inner peripheral surface of the hub is situated halfway between two adjacent engaging portions.

8. A disk drive unit according to claim 1, further comprising a fluid bearing which is provided between the pivot and the hub and supports the hub for rotation.

9. A disk device comprising:
a case;
a disk drive unit according to claim 1 located in the case;
a head which processes information for the recording medium; and
a head actuator which is provided in the case, supports the head for movement, and moves the head with respect to the recording medium.

10. A disk device according to claim 9, wherein the case is opposed to the hub and has through holes through which a jig for supporting the hub from outside the case can be passed.

11. A disk device according to claim 9, wherein each of the engaging portions has a through hole formed in the clamp member.

12. A disk device according to claim 9, wherein each of the engaging portions has a slit formed in the clamp member and opening in the inner peripheral edge.
